(19) United States
(12) Patent Application Publication
(10) Pub. No.: US 2010/0300102 A1
(43) Pub. Date: Dec. 2, 2010

(54) METHOD AND APPARATUS FOR AIR AND FUEL INJECTION IN A TURBINE

(75) Inventors: Mahesh Bathina, Ongole (IN); Chetan Babu Velkur, Chittoor (IN); Senthamil Selvan, Bangalore (IN); Anand Prafulchandra Desai, Valsad (IN); Abinash Baruah, Nagaon (IN)

Correspondence Address: GE Energy-Global Patent Operation;Fletcher Yoder PC, P.O. Box 692289, Houston, TX, 77269-2289, US

(73) Assignee: General Electric Company, Schenectady, NY (US)

(21) Appl. No.: 12/474,097

(22) Filed: May 28, 2009

(51) Int. Cl. F02C 7/22

(52) U.S. Cl. 60/737; 60/748

(57) ABSTRACT

A method includes receiving fuel and air into a cup of a turbine fuel nozzle. The method also includes mixing the fuel and air at least partially within the cup. In addition, the method includes directing a fuel air mixture toward a turbine combustor. The method also includes shielding an inner wall of the cup with a blanket of a protective fluid flow to reduce the possibility of flame holding along the inner wall. The protective fluid flow excludes a combustible mixture of fuel and air.

### BACKGROUND OF THE INVENTION

The subject matter disclosed herein relates to a turbine engine and, more specifically, to a fuel nozzle with an improved design for reducing the possibility of flame holding.

Mixing liquid/gaseous fuel and air affects engine performance and emissions in a variety of engines, such as turbine engines. For example, a turbine engine may employ one or more fuel nozzles to facilitate fuel-air mixing in a combustor. Each fuel nozzle may include structures to direct air, fuel, and optionally other fluids into a combustor. Upon entering the combustor, a fuel and air mixture combusts, thereby driving the turbine engine. In certain conditions, a flame may flashback and/or hold to a surface of the fuel nozzle. Unfortunately, the flame holding subjects the surface of the fuel nozzle to high temperatures, which can damage or reduce performance of the fuel nozzle, thereby reducing performance of the turbine engine.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a turbine engine. The turbine engine includes a combustor. The turbine engine also includes a fuel nozzle disposed in the combustor. The fuel nozzle includes a fuel passage and an air passage directing fuel and air to mix in a cup. The fuel nozzle also includes a baffle in the cup to direct a fluid flow along an inner wall of the cup, wherein the fluid flow is a mixed or non-mixed non-combustible mixture.

In a second embodiment, a system includes a turbine fuel nozzle. The turbine fuel nozzle includes a fuel passage. The turbine fuel nozzle also includes an air passage. In addition, the turbine fuel nozzle includes a cup coupled to the fuel and air passages. The cup is configured to direct a fuel air mixture toward a turbine combustor. The turbine fuel nozzle also includes a baffle disposed inside the cup. The baffle defines an annular passage to direct a protective fluid flow along an inner wall of the cup to reduce the possibility of flame holding along the inner wall. The protective fluid flow excludes a combustible mixture of fuel and air.

In a third embodiment, a method includes receiving fuel and air into a cup of a turbine fuel nozzle. The method also includes mixing the fuel and air at least partially within the cup. In addition, the method includes directing a fuel air mixture toward a turbine combustor. The method also includes shielding an inner wall of the cup with a blanket of a protective fluid flow to reduce the possibility of flame holding along the inner wall. The protective fluid flow excludes a combustible mixture of fuel and air.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an exemplary embodiment of a turbine system having a flame holding resistant fuel nozzle;

FIG. 2 is a cross sectional side view of an exemplary embodiment of the turbine system, as illustrated in FIG. 1, with a combustor having one or more flame holding resistant fuel nozzles;

FIG. 3 is a cutaway side view of an exemplary embodiment of the combustor, as illustrated in FIG. 2, having one or more flame holding resistant fuel nozzles coupled to an end cover of the combustor;

FIG. 4 is a perspective view of an embodiment of the end cover and flame holding resistant fuel nozzles of the combustor, as illustrated in FIG. 3;

FIG. 5 is a cross sectional side view of an exemplary embodiment of the flame holding resistant fuel nozzle, as indicated by line 5-5 in FIG. 4;

FIG. 6 is another cross sectional side view of an exemplary embodiment of the flame holding resistant fuel nozzle, as indicated by line 6-6 in FIG. 5;

FIGS. 7A and 7B are exploded views of exemplary embodiments of a fuel nozzle tip, an annular fuel nozzle head, a baffle, and a fuel nozzle cup of FIGS. 5 and 6, illustrating how these components fit together to form the flame holding resistant fuel nozzle;

FIGS. 8A and 8B are perspective and top views of an exemplary embodiment of the fuel nozzle cup, as illustrated in FIGS. 7A and 7B, with dashed lines illustrating internal passages;

FIGS. 9A and 9B are perspective and top views of an exemplary embodiment of the annular fuel nozzle head, as illustrated in FIGS. 7A and 7B, with dashed lines illustrating internal passages; and

FIG. 10 is a perspective view of an exemplary embodiment of the baffle, as illustrated in FIGS. 7A and 7B.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Flame holding is an important consideration in fuel nozzle design. Individual fuel nozzles are generally evaluated specifically for flame holding in lab tests. Flame holding can significantly damage and/or reduce performance of fuel nozzles, and the entire turbine engine. The embodiments disclosed herein reduce the possibility of flame holding in fuel nozzles, particularly in fuel nozzles used in diffusion combustion systems. In general, the disclosed embodiments reduce the possibility of flame holding by generating a blanket of air or another protective fluid (e.g., not a combustible fuel-air mixture) in peripheral regions close to walls of the fuel nozzle.

In general, flame holding may occur if a flammable mixture resides in low velocity regions in close proximity to a heat source. In fuel nozzles used in diffusion based combustion systems, low velocity regions are generally found near interior walls of the fuel nozzles due to the aerodynamics of the fuel nozzles. In certain fuel nozzles, the interaction of the fuel and air streams during mixing may result in the presence of a flammable mixture in these low velocity regions, which can potentially result in flame holding inside the fuel nozzles. Flame holding inside fuel nozzles may result in the fuel nozzles burning out (e.g., experiencing flame damage due to the flames flashing back), often resulting in unscheduled outages for the turbine engine.

The fuel nozzle may be designed to reduce the possibility of flame holding by taking into consideration such factors as operating conditions (e.g., pressure and temperature), amount of swirl, flow velocities, fuel properties (e.g., composition and flame speeds), and so forth. In addition, the fuel nozzle may be designed in such a way that the average velocities at the fuel nozzle exit are higher than the flame speed at the given operating conditions. However, these design considerations do not factor in local variations in velocities and fuel-air ratio.

As described above, the presence of low velocity regions along with the presence of flammable mixtures make the fuel nozzle susceptible to flame holding. These low velocity regions generally occur close to interior walls of the fuel nozzle. In the disclosed embodiments, air or another protective fluid (e.g., not a combustible fuel-air mixture) may be diverted along the interior walls using a baffle as a flow splitter. In this manner, the protective fluid creates a sheet, film, or layer of flame resistant protection covering the interior walls. The protective fluid covering the interior walls may be at a higher velocity and a composition not readily combustible, thereby reducing the possibility of flame holding on the interior walls. In other words, the protective fluid covering the interior walls may substantially reduce or eliminate the two major factors of flame holding, i.e., a low velocity region and a combustible mixture.

The shape, length, and location of the baffle (both axial and radial) may be designed in various ways to achieve the above mentioned advantages. In general, the baffle may be supported within the fuel nozzle in a variety of ways, such as using metal between air inlet ports. The cross-sectional profile of the baffle may begin at a location near the air inlet ports and extend upstream toward the fuel nozzle exit. The flow area between the baffle and the interior walls of the fuel nozzle may be varied (e.g., by changing the contour, shape, radial location, and so forth, of the baffle) to generate a desired velocity profile at the fuel nozzle exit. Therefore, the disclosed embodiments take into consideration local variations in velocities and fuel-air ratio, especially near the interior wall regions of the fuel nozzle.

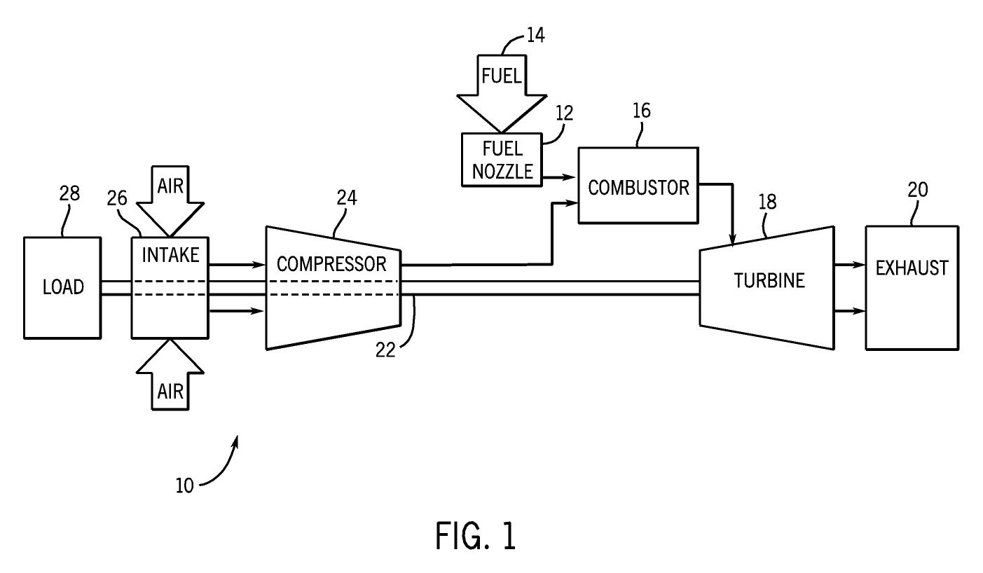

Turning now to the drawings and referring first to FIG. 1, a block diagram of an exemplary embodiment of a turbine system 10 is illustrated. As described in detail below, the disclosed turbine system 10 may employ a plurality of fuel nozzles 12 with an improved design to reduce flame holding in the turbine system 10. The turbine system 10 may use liquid or gas fuel, such as natural gas and/or a hydrogen rich synthetic gas, to drive the turbine system 10. As depicted, a plurality of fuel nozzles 12 intakes a fuel supply 14, mixes the fuel with air, and distributes the air-fuel mixture into a combustor 16. The air-fuel mixture combusts in a chamber within the combustor 16, thereby creating hot pressurized exhaust gases. The combustor 16 directs the exhaust gases through a turbine 18 toward an exhaust outlet 20. As the exhaust gases pass through the turbine 18, the gases force one or more turbine blades to rotate a shaft 22 along an axis of the turbine system 10. As illustrated, the shaft 22 may be connected to various components of the turbine system 10, including a compressor 24. The compressor 24 also includes blades that may be coupled to the shaft 22. As the shaft 22 rotates, the blades within the compressor 24 also rotate, thereby compressing air from an air intake 26 through the compressor 24 and into the fuel nozzles 12 and/or combustor 16. The shaft 22 may also be connected to a load 28, which may be a vehicle or a stationary load, such as an electrical generator in a power plant or a propeller on an aircraft, for example. The load 28 may include any suitable device capable of being powered by the rotational output of turbine system 10.

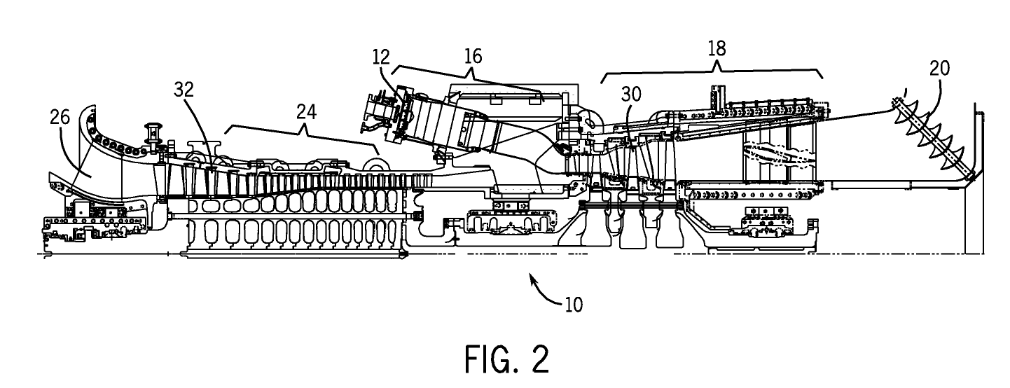

FIG. 2 is a cross sectional side view of an exemplary embodiment of the turbine system 10, as illustrate in FIG. 1. The turbine system 10 includes one or more fuel nozzles 12 located inside one or more combustors 16. The fuel nozzles 12 may be configured to direct a protective fluid along interior walls of the fuel nozzles 12 such that the possibility of flame holding within the fuel nozzles 12 is reduced. In operation, air enters the turbine system 10 through the air intake 26 and is pressurized in the compressor 24. The compressed air may then be mixed with gas for combustion within the combustor 16. For example, the fuel nozzles 12 may inject a fuel-air mixture into the combustor 16 in a suitable ratio for optimal combustion, emissions, fuel consumption, and power output. The combustion generates hot pressurized exhaust gases, which then drive one or more blades 30 within the turbine 18 to rotate the shaft 22 and, thus, the compressor 24 and the load 28. The rotation of the turbine blades 30 causes a rotation of the shaft 22, thereby causing blades 32 within the compressor 24 to draw in and pressurize the air received by the intake 26.

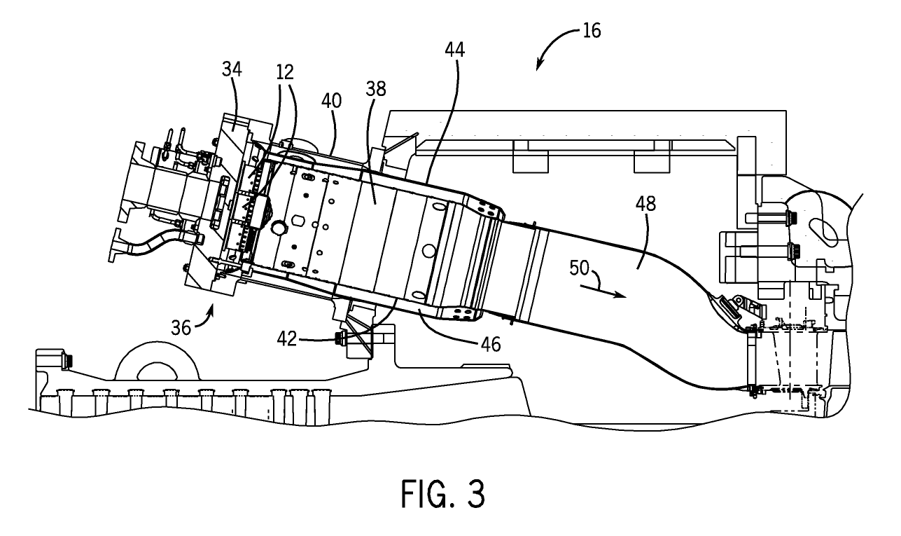

FIG. 3 is a cutaway side view of an exemplary embodiment of the combustor 16, as illustrated in FIG. 2. As illustrated, a plurality of fuel nozzles 12 are attached to an end cover 34, near a head end 36 of the combustor 16. Compressed air and fuel are directed through the end cover 34 and the head end 36 to each of the fuel nozzles 12, which distribute a fuel-air mixture into the combustor 16. Again, the fuel nozzles 12 may be configured to direct a protective fluid along interior walls of the fuel nozzles 12 such that the possibility of flame holding within the fuel nozzles 12 is reduced. The combustor 16 includes a combustion chamber 38, which is generally defined by a combustion casing 40, a combustion liner 42, and a flow sleeve 44. In certain embodiments, the flow sleeve 44 and the combustion liner 42 are coaxial with one another to define a hollow annular space 46, which may enable passage of air for cooling and for entry into the head end 36 and the combustion chamber 38. The design of the combustor 16 provides optimal flow of the air-fuel mixture through a transition piece 48 (e.g., converging section) towards the turbine 18. For example, the fuel nozzles 12 may distribute the pressurized air-fuel mixture into the combustion chamber 38, where combustion of the air-fuel mixture occurs. The resultant exhaust gas flows through the transition piece 48 to the turbine 18, as illustrated by arrow 50, causing the blades 30 of the turbine 18 to rotate, along with the shaft 22.

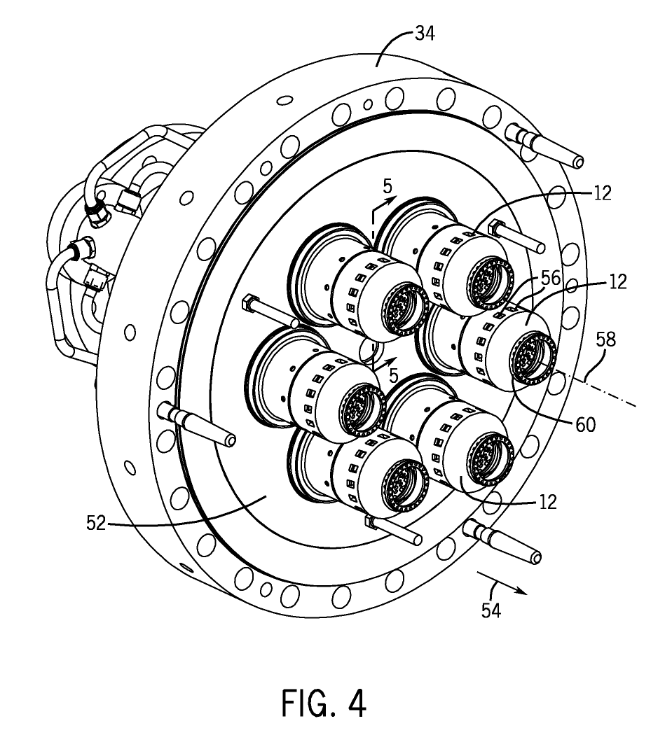

FIG. 4 is a perspective view of an embodiment of the end cover 34 with a plurality of fuel nozzles 12 attached to an end cover surface 52 of the end cover 34. In the illustrated embodiment, the fuel nozzles 12 are attached to the end cover surface 52 in an annular arrangement. However, any suitable number and arrangement of the fuel nozzles 12 may be attached to the end cover surface 52. In certain embodiments, each fuel nozzle 12 may provide a blanket, film, or layer of protective fluid (e.g., air, fuel, water, or generally not a combustible fuel-air mixture) along interior walls to reduce the possibility of flame holding inside or near the fuel nozzle 12. In this manner, the fuel nozzles 12 may be described as inducing a shift in the fuel-air mixture and combustion in a downstream direction 54, away from the fuel nozzles 12. In other words, a lesser amount of fuel-air mixing may occur inside the fuel nozzles 12, at least along the interior walls of the fuel nozzles 12.

Air inlets 56 into the fuel nozzles 12 may be directed inward, toward an axis 58 of each fuel nozzle 12, thereby enabling an air stream to mix with a fuel stream as it is traveling in the downstream direction 54 into the combustor 16. Further, in certain embodiments, the air streams and the fuel streams may swirl in opposite directions, such as clockwise and counter clockwise, respectively, to enable a better mixing process. In other embodiments, the air streams and the fuel streams may swirl in the same direction to improve mixing, depending on system conditions and other factors.

As discussed in greater detail below, a baffle may be used within a fuel nozzle cup 60 of each fuel nozzle 12 to direct an air flow (or another protective fluid) along an inner wall of the fuel nozzle cup 60, thereby generating a blanket of air in the peripheral regions close to an inner wall of the fuel nozzle cup 60. By doing so, the blanket of air reduces the possibility of flame holding in the vicinity of the end cover surface 52 and the fuel nozzles 12. As appreciated, certain embodiments of the fuel nozzle 12 may direct only air, only fuel, only water, or only some other fluid not readily combustible along the interior walls of the fuel nozzle 12.

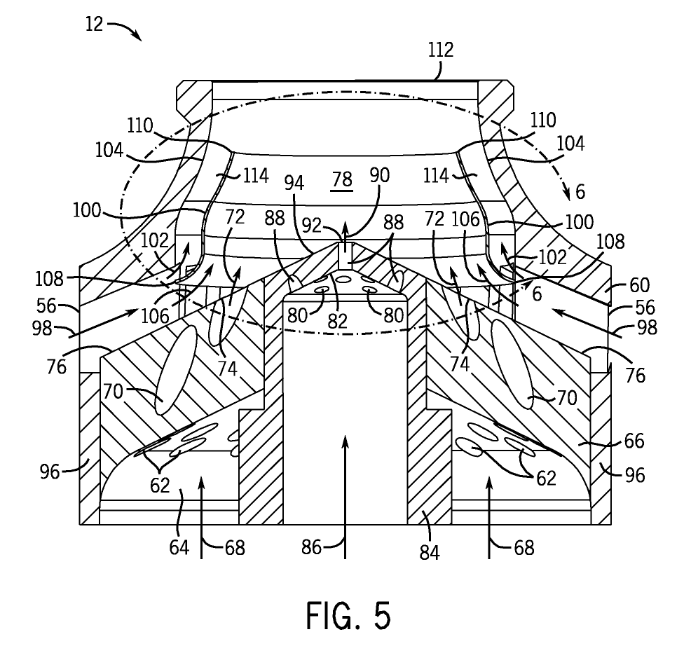

FIG. 5 is a cross sectional side view of an exemplary embodiment of the fuel nozzle 12, as indicated by line 5-5 in FIG. 4. As depicted, the fuel nozzle 12 includes several passages for air and fuel to pass through portions of the fuel nozzle 12. In particular, fuel inlets 62 may be located on an axially upstream face 64 of an annular fuel nozzle head 66. In certain embodiments, fuel 68 may flow through the fuel inlets 62. The fuel 68 may produce fuel streams through fuel passages 70 within the annular fuel nozzle head 66. In certain embodiments, as described in greater detail below, the fuel passages 70 of the annular fuel nozzle head 66 may be configured to facilitate swirling of the fuel 68 through the annular fuel nozzle head 66. As illustrated by arrows 72, the fuel 68 may exit the annular fuel nozzle head 66 through fuel outlets 74 located on an axially downstream face 76 of the annular fuel nozzle head 66. Therefore, the fuel 68 enters a mixing zone 78 defined by the fuel nozzle cup 60 of the fuel nozzle 12.

In addition, fuel inlets 80 may be located on an axially upstream face 82 of a fuel nozzle tip 84. In certain embodiments, fuel 86 may flow through the fuel inlets 80. The fuel 86 may produce fuel streams through fuel passages 88 within the fuel nozzle tip 84. The fuel passages 88 of the fuel nozzle tip 84 may also be configured to facilitate swirling of the fuel 86 through the fuel nozzle tip 84. As illustrated by arrow 90, the fuel 86 may exit the fuel nozzle tip 84 through fuel outlets 92 located on an axially downstream face 94 of the fuel nozzle tip 84. Therefore, the fuel 86 enters the mixing zone 78 within the fuel nozzle cup 60 as well.

In certain embodiments, the fuel 68 flowing through the annular fuel nozzle head 66 may be the same as the fuel 86 flowing through the fuel nozzle tip 84. However, in other embodiments, the fuel 68 flowing through the annular fuel nozzle head 66 may be different than the fuel 86 flowing through the fuel nozzle tip 84 (e.g., gas plus gas, liquid plus gas, gas plus liquid, liquid plus liquid, and so forth). Although the annular fuel nozzle head 66 and the fuel nozzle tip 84 are described herein as separate parts, in certain embodiments, the annular fuel nozzle head 66 and the fuel nozzle tip 84 may be integrated into a single part. Moreover, in certain embodiments, the annular fuel nozzle head 66 and the fuel nozzle tip 84 may receive a single stream of fuel, as opposed to the separate streams of fuel 68, 86 illustrated herein.

As described above with respect to FIG. 4, the air inlets 56 may be located through walls 96 of the fuel nozzle cup 60. Air 98 may enter through the air inlets 56 and be directed toward the mixing zone 78 within the fuel nozzle cup 60. However, instead of mixing directly with the fuel 68, 86 within the mixing zone 78, the air 98 may first encounter a baffle 100, which may be held in place within the mixing zone 78 in various ways. For instance, metal between the air inlets 56 may hold the baffle 100 in place. The baffle 100 functions to split the flow of air 98 into two air flows, an outer air flow 102 between the baffle 100 and an inner wall 104 of the fuel nozzle cup 60 and an inner air flow 106 toward the center of the mixing zone 78. In other words, the baffle 100 acts as a stationary wall for deflecting and channeling the air 98 into the outer and inner air flows 102, 106. As discussed in further detail below, the outer air flow 102 increases the velocity and/or reduces the combustibility of fluid along the inner wall 104, thereby reducing the possibility of flame holding.

In general, the cross-sectional profile of the baffle 100 may begin at a leading edge 108 near the air inlets 56 and extend to a trailing edge 110 just upstream of an exit 112 from the fuel nozzle 12. In certain embodiments, the contour of the cross-sectional profile of the baffle 100 may be generally similar to the contour of the inner wall 104 of the fuel nozzle cup 60. However, in other embodiments, an annular passage 114 between the baffle 100 and the inner wall 104 of the fuel nozzle cup 60 may converge, diverge, or alternatively converge and diverge, in a downstream direction of the outer air flow 102. For example, a converging air flow may be beneficial to increase the air velocity and reduce the possibility of flame holding along the inner wall 104.

The split of the air 98 between the outer and inner air flows 102, 106 may vary between implementations and specific conditions. For instance, in certain embodiments, the baffle 100 may be located closer to the axially downstream face 76 of the annular fuel nozzle head 66. In these embodiments, more air 98 may be split into the outer air flow 102 than to the inner air flow 106. Conversely, in other embodiments, the baffle 100 may be located further away from the axially downstream face 76 of the annular fuel nozzle head 66. In these embodiments, more air 98 may be split into the inner air flow 106 than to the outer air flow 102. In addition to varying the axial location of the baffle 100 in this manner, the amount of air 98 split into the outer air flow 102 may also be varied by changing the contour, shape, radial location, and other characteristics of the baffle 100. In general, the amount of air 98 split into the outer air flow 102 may be less than 40% of the total flow of air 98. However, this percentage may vary between 5%, 10%, 15%, 20%, 25%, 30%, 35%, 40%, 45%, 50%, 55%, 60%, or any other discrete value in this range (e.g., 12%). These percentages may be based on mass flow rate, volume, or any other comparable measure of air flow.

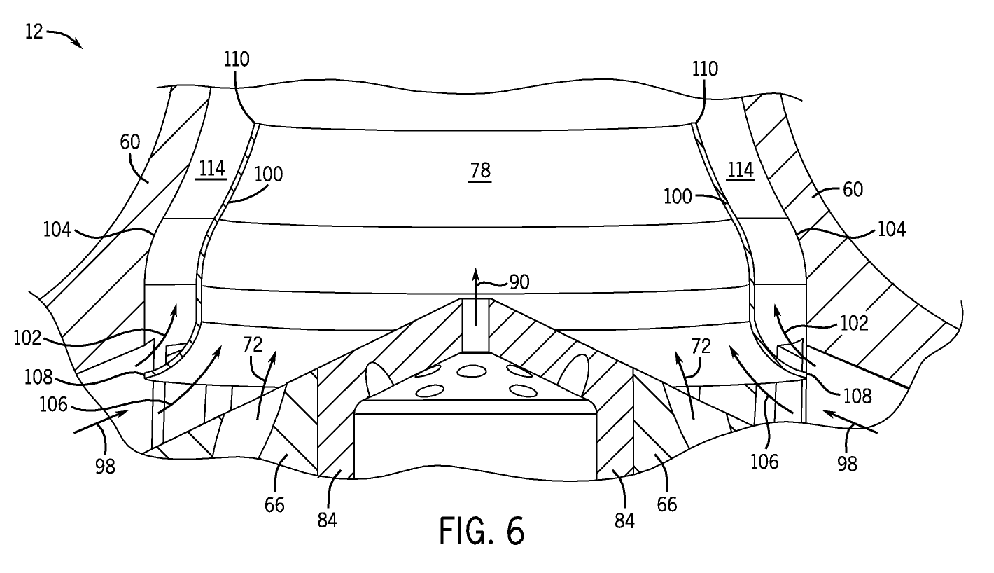

FIG. 6 is another cross sectional side view of an exemplary embodiment of the fuel nozzle 12, as indicated by line 6-6 in FIG. 5. By splitting the air 98 into the outer and inner air flows 102, 106, the baffle 100 may reduce the possibility of flame holding along the inner wall 104 of the fuel nozzle cup 60. In general, the outer air flow 102 may generate a blanket of air in the peripheral regions of the mixing zone 78 close to the inner wall 104 of the fuel nozzle cup 60. In others words, fuel 68, 86 from the annular fuel nozzle head 66 and the fuel nozzle tip 84 may, to a certain extent, be precluded from entering the annular passage 114 between the baffle 100 and the inner wall 104 of the fuel nozzle cup 60. Therefore, the amount of flammable mixture near the inner wall 104 of the fuel nozzle cup 60 may be reduced. In addition, the velocity of air along the inner wall 104 of the fuel nozzle cup 60 may be increased by at least approximately 5, 10, 15, 20, 25, 30, 40, 50, 60, 70, 80, 90, or 100 percent (or any other discrete value in this range) relative to the previous flows along the inner wall 104 and/or relative to flow through the central portion of the mixing zone 78. Since lower velocity regions within the mixing zone 78 are typically more susceptible to flame holding, increasing the velocity of air along the inner wall 104 of the fuel nozzle cup 60 may further reduce the possibility of flame holding. As such, due in part to both of these considerations, there will be less chance of flame holding within the fuel nozzle cup 60 of the fuel nozzle 12.

Although described herein as splitting the flow of air 98, in certain embodiments, the baffle 100 may also be used to split the flow of other fluid flows into the mixing zone 78. For example, in certain embodiments, the baffle 100 may be used to split the flow of another fuel into the mixing zone 78. Moreover, in other embodiments, the baffle 100 may be used to split the flow of a diluent into the mixing zone 78. More specifically, in certain embodiments, the annular fuel nozzle head 66 may include diluent passages along an outer periphery of the annular fuel nozzle head 66. These diluent passages may allow a diluent to flow across the baffle 100, as opposed to the air 98.

Whichever fluid (e.g., air 98, another fuel, diluent, and so forth) is split into the annular passage 114 between the baffle 100 and the inner wall 104 of the fuel nozzle cup 60, this fluid may generally be described as a protective fluid which protects the fuel nozzle 12 against flame holding along the inner wall 104 of the fuel nozzle cup 60. As such, the protective fluid reduces the possibility of flame holding along the inner wall 104 of the fuel nozzle cup 60. The protective fluid, whether it is air 98, fuel, a diluent, or a combination of any of the fluids, may generally be non-combustible. For example, in certain embodiments, the protective fluid may be a mixture of non-combustible fluids, such as air, water, nitrogen, or another diluent. However, in other embodiments, the protective fluid may be a mixture of fluids which do not fall within a combustible region. Accordingly, the fuel nozzle 12 will be less likely to experience a combustible mixture and flame holding along the inner wall 104 of the fuel nozzle cup 60.

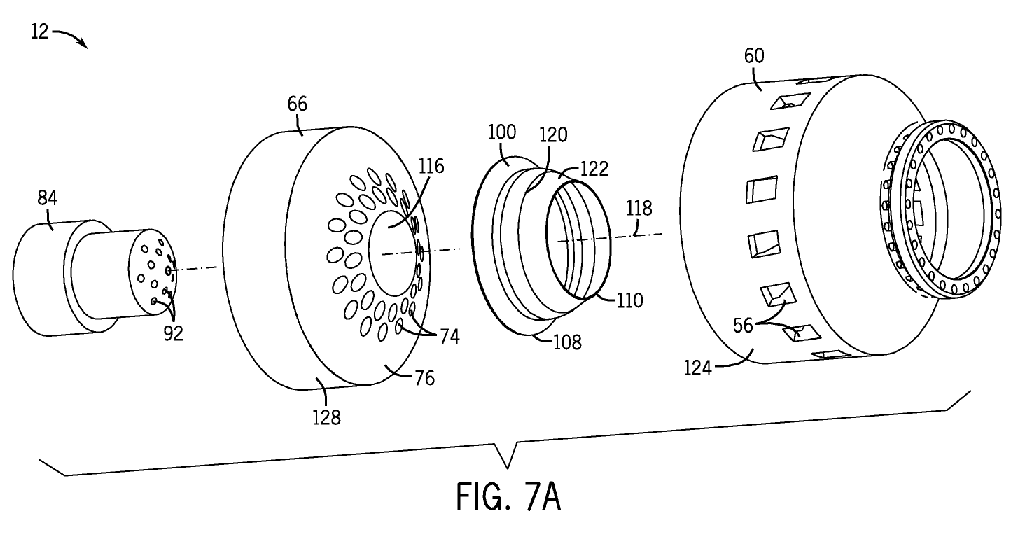

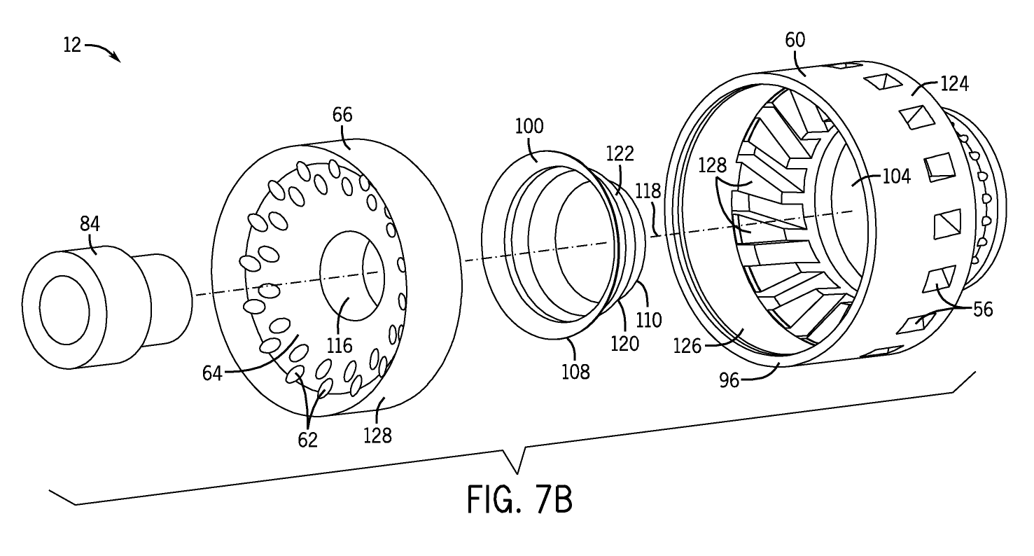

FIGS. 7A and 7B are exploded views of exemplary embodiments of the fuel nozzle tip 84, the annular fuel nozzle head 66, the baffle 100, and the fuel nozzle cup 60 of FIGS. 5 and 6, illustrating how these components fit together to form the fuel nozzle 12. As illustrated, the fuel nozzle tip 84 may generally be configured to fit securely within a circular opening 116 through the annular fuel nozzle head 66 along an axis 118 of the fuel nozzle 12. As described above, in certain embodiments, the fuel nozzle tip 84 and the annular fuel nozzle head 66 may be integrated into one part. However, in the embodiments illustrated in FIGS. 7A and 7B, the fuel nozzle tip 84 and the annular fuel nozzle head 66 may be separate parts of the fuel nozzle 12. As described above, one reason why the fuel nozzle tip 84 and the annular fuel nozzle head 66 are separate parts is the possibility that separate fuels 86, 68 will be directed through the fuel nozzle tip 84 and the annular fuel nozzle head 66, respectively.

As illustrated, the baffle 100 may generally be located near the annular fuel nozzle head 66 such that the baffle 100 is located between the fuel outlets 74 on the axially downward face 76 of the annular fuel nozzle head 66 and the fuel nozzle cup 60. As described above with respect to FIGS. 5 and 6, this configuration enables the baffle 100 to isolate air 98 or another protective fluid from fuel 68, 86 within the annular passage 114 defined between the baffle 100 and the inner wall 104 of the fuel nozzle cup 60. As described in greater detail below, in certain embodiments, the baffle 100 may include one or more grooves 120 on a radially outward wall 122 of the baffle 100. In addition, in other embodiments, the fuel nozzle cup 60 may include one or more grooves on the inner wall 104 of the fuel nozzle cup 60. These grooves may function as a swirling mechanism to enable swirling of the air 98 or other protective fluid either in a clockwise or counter-clockwise direction through the annular passage 114 defined between the baffle 100 and the inner wall 104 of the fuel nozzle cup 60.

As illustrated, the fuel nozzle cup 60 may include a plurality of air inlets 56 spaced circumferentially along an outer wall 124 of the fuel nozzle cup 60. The air inlets 56 function as inlet ports for the air 98, which may be mixed with the fuel 68, 86 within the mixing zone 78 within the fuel nozzle cup 60. Although illustrated herein as a plurality of discrete air inlets 56, in certain embodiments, the air inlets 56 may be replaced by a continuous annular opening. The leading edge 108 of the baffle 100 may generally be located near the air inlets 56, such that the air 98 may be split by the baffle 100. In addition, the fuel nozzle tip 84, annular fuel nozzle had 66, and baffle 100 may all generally be disposed within the fuel nozzle cup 60. More specifically, the fuel nozzle tip 84 and annular fuel nozzle head 66 may be configured to fit securely within an axially upstream portion 126 of the walls 96 of the fuel nozzle cup 60. More specifically, an outer wall 128 of the annular fuel nozzle head 66 may be configured to fit securely adjacent the axially upstream portion 126 of the inner wall 104 of the fuel nozzle cup 60.

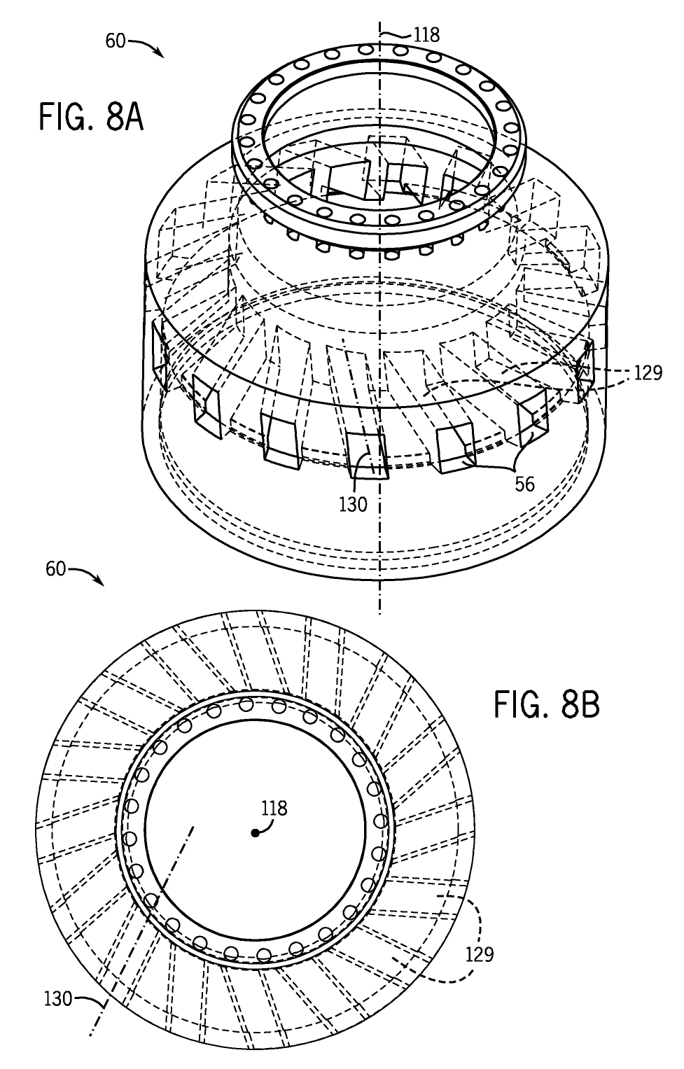

As described above, in certain embodiments, the components of the fuel nozzle 12 may facilitate swirling of the air 98, fuel 68, 86, and other fluids within the fuel nozzle 12. For example, FIGS. 8A and 8B are perspective and top views of an exemplary embodiment of the fuel nozzle cup 60, as illustrated in FIGS. 7A and 7B, with dashed lines illustrating internal passages. As illustrated, the fuel nozzle cup 60 may include a plurality of carved-out portions which form rectangular air inlet passages 129 through which the air 98 may enter the fuel nozzle cup 60. Although the air inlets 56 and the air inlet passages 129 are illustrated herein as generally rectangular, the air inlets 56 and the air inlet passages 129 may include other shapes, such as circular, semi-circular, and so forth. However, the generally rectangular shape of the air inlet passages 129 may, in part, be due to the fact that one side of the rectangular shape is formed with the adjacent axially downstream face 76 of the annular fuel nozzle head 66.

As illustrated, in certain embodiments, the air inlet passages 129 may facilitate swirling of the air 98 through the mixing zone 78. In particular, the air inlet passages 129 may be configured such that axes 130 through the air inlet passages 129 do not pass directly through the axis 118 of the fuel nozzle 12. In other words, the air 98 may not enter the mixing zone 78 directly toward the axis 118. Rather, the air 98 may enter the mixing zone 78 in a somewhat rotational (e.g., swirling) motion about the axis 118. The swirling motion of the air 98 may further reduce the possibility of flame holding along the inner wall 104 of the fuel nozzle cup 60. In particular, since the air 98 may include a more circumferential component of velocity, the air 98 may generally be more apt to travel through the annular passage 114 between the baffle 100 and the inner wall 104 of the fuel nozzle cup 60 instead of directly into the mixing zone 78.

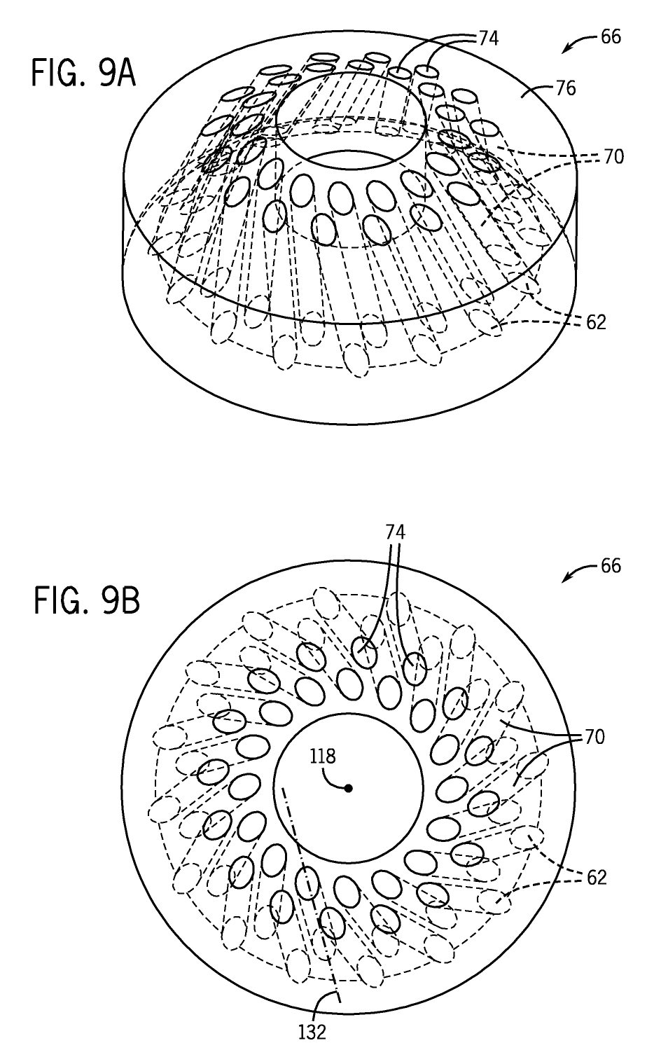

FIGS. 9A and 9B are perspective and top views of an exemplary embodiment of the annular fuel nozzle head 66, as illustrated in FIGS. 7A and 7B, with dashed lines illustrating internal passages. As illustrated, the annular fuel nozzle head 66 may include a plurality of fuel passages 70 which extend from fuel inlets 62 on the axially upstream face 64 of the annular fuel nozzle head 66 to fuel outlets 74 on the axially downstream face 76 of the annular fuel nozzle head 66. In certain embodiments, the fuel passages 70 may also facilitate swirling of the fuel 68 through the mixing zone 78. In particular, the fuel passages 70 may be configured such that axes 132 through the fuel passages 70 also do not pass directly through the axis 118 of the fuel nozzle 12. In other words, the fuel 68 may not enter the mixing zone 78 directly toward the axis 118. Rather, the fuel 68 may enter the mixing zone 78 in a somewhat rotational (e.g., swirling) motion about the axis 118. The swirling motion of the fuel 68 may further reduce the possibility of flame holding along the inner wall 104 of the fuel nozzle cup 60. In particular, since the fuel 68 may include both an axial and circumferential component of velocity, the fuel 68 may be more apt to stay within the mixing zone 78 as opposed to entering the annular passage 114 between the baffle 100 and the inner wall 104 of the fuel nozzle cup 60.

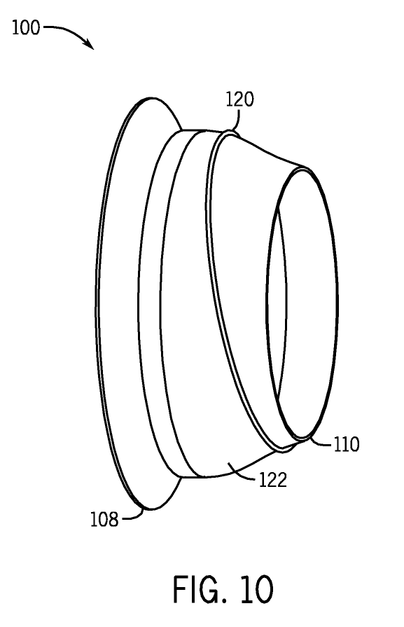

FIG. 10 is a perspective view of an exemplary embodiment of the baffle 100, as illustrated in FIGS. 7A and 7B. As described above, the baffle 100 may include one or more grooves 120 on the radially outward wall 122 of the baffle 100. As illustrated, the groove(s) 120 may extend around the radially outward wall 122 of the baffle 100 in a generally helical fashion. This helical shape of the groove(s) 120 may further facilitate swirling of the air 98 or other protective fluid through the annular passage 114 defined between the baffle 100 and the inner wall 104 of the fuel nozzle cup 60.

As described above, the swirling facilitated by the fuel nozzle cup 60, the annular fuel nozzle head 66, and the baffle 100 as shown in FIGS. 8 through 10 may be beneficial in that it may help produce a desired mix of fuel and air streams from the fuel nozzle 12. For example, in certain embodiments, the air streams and the fuel streams may swirl in opposite directions, such as clockwise and counter clockwise, respectively, to enable a better mixing process. In other embodiments, the air streams and the fuel streams may swirl in the same direction to improve mixing, depending on system conditions and other factors. The swirling nature of the air and fuel streams may help reduce the possibility of flame holding within the fuel nozzle 12. In addition, in certain embodiments, the speed of the air streams and/or the fuel streams may be varied in order to establish a desired mix from the fuel nozzle 12.

Technical effects of the disclosed embodiments include providing systems and methods for shielding an inner wall 104 of the fuel nozzle cup 60 with a blanket of a protective fluid flow to reduce the possibility of flame holding along the inner wall 104 of the fuel nozzle cup 60. The embodiments disclosed herein help to avoid flame holding in any fuel nozzle 12 and, in particular, fuel nozzles 12 designed for diffusion combustion. Avoidance of flame holding results in increased fuel nozzle life and more reliable operation of the combustor 16 of the turbine system 10. Another primary advantage of the disclosed embodiments is the reduction of unscheduled outages due to fuel nozzle burnout (e.g., flame damage due to the flames flashing back). In addition, with the growing demand for synthetic gases and other fuel sources having low heating values in power generation systems, the disclosed embodiments provide a competitive advantage as the fuel nozzles 12 may be distinguished based on performance and durability. Furthermore, the disclosed embodiments may easily be used to retrofit existing fuel nozzles 12 with the systems and methods disclosed herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
a turbine engine, comprising:
a combustor; and
a fuel nozzle disposed in the combustor, wherein the fuel nozzle comprises a fuel passage and an air passage directing fuel and air to mix in a cup, and the fuel nozzle comprises a baffle in the cup to direct a fluid flow along an inner wall of the cup, wherein the fluid flow is a mixed or non-mixed non-combustible mixture.

2. The system of claim 1, wherein the fluid flow is only an air flow, and the baffle splits the air flow from the air passage into a first air flow between the baffle and the cup and a second air flow inside the baffle.

3. The system of claim 2, wherein the first air flow comprises less than approximately 40 percent of the air flow.

4. The system of claim 2, wherein the first air flow comprises between approximately 15 to 20 percent of the air flow.

5. The system of claim 1, wherein the fluid flow is only a fuel flow.

6. The system of claim 1, wherein the fuel nozzle comprises a diluent passage, and the fluid flow comprises a diluent flow.

7. The system of claim 1, wherein the baffle and the cup define an annular passage for the fluid flow, and the baffle or the cup comprises a swirling mechanism configured to induce swirl of the fluid flow in a clockwise or counter-clockwise direction.

8. The system of claim 1, wherein the baffle and the cup define an annular passage in a downstream direction of flow of the fluid flow.

9. A system, comprising:
a turbine fuel nozzle, comprising:
a fuel passage;
an air passage;
a cup coupled to the fuel and air passages, wherein the cup is configured to direct a fuel air mixture toward a turbine combustor; and
a baffle disposed inside the cup, wherein the baffle defines an annular passage to direct a protective fluid flow along an inner wall of the cup to reduce the possibility of flame holding along the inner wall, and the protective fluid flow excludes a combustible mixture of fuel and air.

10. The system of claim 9, wherein the baffle splits the protective fluid flow into a first fluid flow between the baffle and the cup and a second fluid flow inside the baffle.

11. The system of claim 10, wherein the first fluid flow is only an air flow from the air passage, or only a fuel flow from the fuel passage, or only a diluent flow from a diluent passage, or a mixture of the air flow, the fuel flow, and/or the diluent flow.

12. The system of claim 10, wherein the first fluid flow comprises less than approximately 40 percent of the protective fluid flow.

13. The system of claim 10, wherein the first fluid flow comprises between approximately 15 to 20 percent of the protective fluid flow.

14. The system of claim 9, wherein the baffle and the cup define an annular passage for the protective fluid flow, and the baffle or the cup comprises a swirling mechanism configured to induce swirl of the protective fluid flow in a clockwise or counter-clockwise direction.

15. The system of claim 9, wherein the baffle and the cup define an annular passage in a downstream direction of flow of the protective fluid flow.

16. The system of claim 9, wherein the baffle and the cup define an annular passage for the protective fluid flow, and the protective fluid flow enters the annular passage through a plurality of discrete openings.

17. The system of claim 9, wherein the baffle and the cup define an annular passage for the protective fluid flow, and the protective fluid flow enters the annular passage through a continuous annular opening.

18. A method, comprising:
receiving fuel and air into a cup of a turbine fuel nozzle;
mixing the fuel and air at least partially within the cup;
directing a fuel air mixture toward a turbine combustor; and
shielding an inner wall of the cup with a blanket of a protective fluid flow to reduce the possibility of flame holding along the inner wall, wherein the protective fluid flow excludes a combustible mixture of fuel and air.

19. The method of claim 18, comprising splitting the protective fluid flow via a baffle to define a first fluid flow between the cup and the baffle and a second fluid flow inside the baffle, wherein the first fluid flow is only an air flow, or only a fuel flow, or only a diluent flow, or a combination of the air flow, the fuel flow, and/or the diluent flow.

20. The method of claim 19, comprising swirling the first fluid flow in a downstream direction between the cup and the baffle.
